(19) United States
(12) Patent Application Publication
(10) Pub. No.: US 2018/0131705 A1
(43) Pub. Date: May 10, 2018

(54) Visibility of Non-Benign Network Traffic

(71) Applicant: QUALCOMM Incorporated, San Diego, CA (US)

(72) Inventors: Ramin Samadani, Menlo Park, CA (US); Yin Chen, Campbell, CA (US); Keen Yuun Sung, San Jose, CA (US); Nayeem Islam, Palo Alto, CA (US)

(21) Appl. No.: 15/428,944

(22) Filed: Feb. 9, 2017

Related U.S. Application Data
(60) Provisional application No. 62/420,465, filed on Nov. 10, 2016.

(51) Int. Cl. H04L 29/06; H04L 12/26; G06N 99/00

(52) U.S. Cl. CPC H04L 63/1408; G06N 99/005; H04L 69/22; H04L 43/0876

(57) ABSTRACT

Embodiments provide methods of protecting computing devices from malicious activity. A processor of a network device may receive a first network traffic flow of a monitoring computing device and a malicious activity tag identifying a malicious behavior of the first network traffic flow. The processor may determine a characteristic of the first network traffic flow based at least in part on information in the first network traffic flow and the malicious activity tag. The processor may receive a second network traffic flow from a non-monitoring computing device, and may associate the malicious activity tag and the second network traffic flow based on a characteristic of the second network traffic flow based at least in part on information in the second network traffic flow and the characteristic of the first network traffic flow.

### RELATED APPLICATIONS

This application claims the benefit of priority to U.S. Provisional Patent Application No. 62/420,465 entitled “Visibility of Malicious Network Traffic” filed Nov. 10, 2016, the entire contents of which are incorporated herein by reference.

### BACKGROUND

The power and complexity computing devices (e.g., mobile electronic devices, cellular phones, tablets, laptops, etc.) provides increased access to information and communication resources. However, advancements in computing devices have also created new opportunities for malicious exploitation of such computing devices. For example, malicious software (“malware”) running on a computing device may exfiltrate information from the computing device or perform illicit activities on the network. Increasing malicious exploitation of computing devices calls for advanced methods of detecting and mitigating such exploitation of computing devices and communication networks.

Some computing devices have the capability of detecting malware by analyzing their behaviors. However, a network is likely to have many computing devices that lack such capabilities, and the presence of such devices may present an opportunity for exploitation of such devices or of the communication network by malware.

### SUMMARY

Various embodiments include methods that may be implemented on a processor of a network device for protecting computing devices from non-benign activity. Various embodiments may include receiving a first network traffic flow of a monitoring computing device and a malicious activity tag identifying a non-benign behavior of the first network traffic flow, determining one or more characteristics of the first network traffic flow associated with the non-benign behavior, receiving a second network traffic flow from a non-monitoring computing device, and determining whether the second network traffic flow represents non-benign activity by comparing the one or more characteristics of the first network traffic flow associated with the non-benign activity to the second network traffic flow. Some embodiments may further include clustering the first network traffic flow and the second network traffic flow based on characteristic of the second network traffic flow and the one or more characteristics of the first network traffic flow associated with the non-benign activity.

In some embodiments, the one or more characteristics of the first network traffic flow associated with the non-benign activity may include information in packet headers of the first network traffic flow. In some embodiments, the one or more characteristics of the first network traffic flow associated with the non-benign activity may include one or more traffic features of the first network traffic flow. In some embodiments, determining one or more characteristics of the first network traffic flow associated with the non-benign activity may include learning, by a semi-supervised application of the network device, associations of the malicious activity tag with one or more characteristics of the first network traffic flow.

In some embodiments, determining whether the second network traffic flow represents non-benign activity by comparing the one or more characteristics of the first network traffic flow associated with the non-benign activity may include comparing packet header information of the second network traffic flow with packet header information associated with the non-benign activity, determining whether the packet header information of the second network traffic flow matches the associated with the non-benign activity, and associating the malicious activity tag and the second network traffic flow in response to determining that the packet header information of the second network traffic flow matches packet header information associated with the non-benign activity.

In some embodiments, determining whether the second network traffic flow represents non-benign activity by comparing the one or more characteristics of the first network traffic flow associated with the non-benign activity may include comparing a traffic feature of the second network traffic flow with a traffic feature associated with the non-benign activity, determining whether the traffic feature of the second network traffic flow matches the traffic feature associated with the non-benign activity, and associating the malicious activity tag and the second network traffic flow in response to determining that the traffic feature of the second network traffic flow matches the traffic feature associated with the non-benign activity.

In some embodiments, determining whether the second network traffic flow represents non-benign activity by comparing the one or more characteristics of the first network traffic flow associated with the non-benign activity may include comparing packet header information of the second network traffic flow with packet header information associated with the non-benign activity, comparing one or more traffic features of the second network traffic flow with one or more traffic features associated with the non-benign activity, determining whether the packet header information and one or more traffic features of the second network traffic flow correlate to packet header information and the one or more traffic features associated with the non-benign activity within a threshold degree of correlation, and associating the malicious activity tag and the second network traffic flow in response to determining that the packet header information and one or more traffic features of the second network traffic flow correlate to packet header information and the one or more traffic features associated with the non-benign activity within a threshold degree of correlation.

Further embodiments may include a network device including a processor configured with processor-executable instructions to perform operations of the methods summarized above. Further embodiments may include a network device including means for performing functions of the methods summarized above. Further embodiments may include processor-readable storage media on which are stored processor executable instructions configured to cause a processor of a network device to perform operations of the methods summarized above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system block diagram of a system suitable for use with various embodiments.

FIG. 2A is a process flow diagram illustrating an embodiment method for protecting computing devices from malicious activity.

FIG. 2B is a process flow diagram illustrating an embodiment method for protecting computing devices from malicious activity.

FIG. 3 illustrates an example of traffic flow characteristics according to an embodiment.

FIG. 4A is a plot of packet interarrival times for two different network traffic flows.

FIG. 4B is a comparison plot of packet interarrival times for two different network traffic flows at two different packet lengths.

FIG. 4C is a comparison plot of packet densities for two different network traffic flows at two different packet lengths.

FIG. 5 is a component block diagram of a computing device suitable for implementing various embodiments.

FIG. 6 is a component block diagram of a computing device suitable for implementing various embodiments.

FIG. 7 is a component block diagram of a server suitable for implementing various embodiments.

FIG. 8 is a component block diagram of a network device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments provide methods of using information from or related to network traffic flows to identify and/or characterize applications running on computing devices on a communication network. Various embodiments may apply machine learning techniques to learn associations of non-benign or malicious activities identified by a subset of computing devices with recognizable characteristics of network traffic flows, characterizations of the network traffic flows, and/or source applications of the network traffic flows, thereby enabling monitoring of non-benign or malicious activity among all computing devices. Various embodiments may enable the detection of and protection of computing devices from non-benign or malicious activity.

The terms “computing device” and “mobile computing device” are used interchangeably herein to refer to any one or all of cellular telephones, smartphones, personal or mobile multi-media players, personal data assistants (PDAs), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

As used herein, the term “monitoring computing device” refers to a computing device that is configured to send information characterizing or identifying a network traffic flow and/or information characterizing or identifying an application of the computing device that is the source of a network traffic flow, as further described below.

As used herein, the term “non-monitoring computing device” refers to a computing device that is not configured to send such information. Such information may include, for example, a malicious activity tag that may indicate information about a network traffic flow in which malicious activity has occurred or is occurring. Such information may also include, for example, information identifying a particular application of the computing device as a source of, or the application originating and/or receiving, a particular network traffic flow.

Various embodiments are described herein using the term “server” to refer to any computing device capable of functioning as a server, such as a master exchange server, web server, mail server, document server, content server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server-type functionality that can be implemented on a computing device thereby enabling it to function as an Internet server (e.g., an enterprise e-mail server) only to the extent necessary to provide the functionality described herein.

The term “network device” may be used in this application to refer to any computing device capable of forwarding packets between computing devices. Network devices may include computing devices such as routers, switches, base stations, gateways, network hubs, or any other type computing device configured to forward packets between computing devices. A network device may be a dedicated computing device or a computing device including a networking module (e.g., running an application which may cause the computing device to operate as a network device, such as a router). While various examples of network devices, such as routers, switches, base stations, etc., may be discussed herein to better illustrate aspects of various embodiments. However, those example network devices, such as routers, switches, base stations, etc., are merely used as examples, and other type computing device configured to forward packets between computing devices may be substituted for those example network devices in various embodiments.

In various embodiments, a network device may cluster network traffic flows for monitoring computing devices and non-monitoring computing devices to enable information from monitoring computing devices to be extended to non-monitoring computing devices.

In various embodiments, a communications network may include at least one computing device configured to monitor its behaviors for malicious activity and to label network traffic flows being sent and/or received by that computing device accordingly. The computing device may determine whether activities occurring during the network traffic flows are normal (or benign) or non-benign (e.g., malicious). Non-benign or malicious activities may include, for example, activities causing the leakage of an International Mobile Equipment Identity (IMEI) of the computing device, activities tracking the computing device location, an unexpected or atypical connection for a particular application or for a particular type of communication, communication with a malicious server, communication activity typically associated with malware, or any other activity that may negatively affect a computing device, a server, or another element of the communication network. In response to detecting malicious activities during a network traffic flow, the computing device may generate a malicious activity tag and send the malicious activity tag to the network device. Such a malicious activity tag may be included within packet headers as an additional field of information, or transmitted via another channel or mechanism (i.e., via “out-of-band” communications).

In various embodiments, malicious activity tags may indicate information about the network traffic flows on which non-benign or malicious activities occurred. The indications in a malicious activity tag may enable a network device, such as a router, receiving the malicious activity tag to associate the malicious activity tag with a network traffic flow. As examples, a malicious activity tag may include one or more of an identifier (ID) of the monitoring computing device sending the malicious activity tag (e.g., the monitoring computing device's Media Access Control (MAC) ID), a source Internet Protocol (IP) address of the network traffic flow on which the malicious activity occurred, a source port of the network traffic flow on which the non-benign or malicious activity occurred, a destination IP address of the network traffic flow on which the non-benign or malicious activity occurred, and a destination port of the network traffic flow on which the non-benign or malicious activity occurred. In some embodiments, malicious activity tags may indicate a type of non-benign or malicious activity that was detected by the monitoring computing device. Example indications of types of non-benign or malicious activities may include “IMEI leakage”, “location tracking”, “unexpected connection”, or any other indication. In some embodiments, malicious activity tags may be sent in an out of band message, such as an overhead signaling message, from a monitoring computing device to the network device.

In various embodiments, monitoring computing devices may provide to the network device information identifying a source application of a network traffic flow from the monitoring computing device. For example, a monitoring computing device may provide information identifying a particular application (e.g., a particular streaming media application, messaging application, browsing application, game application, and the like) as the source application of a particular network traffic flow. In some embodiments, a monitoring computing device may provide the information identifying the source application in the packet header of network traffic from the computing device. In some embodiments, a monitoring computing device may provide information identifying source applications in an out of band message to the network device.

In various embodiments, the processor of the network device may determine one or more characteristics of a traffic flow from a computing device, such as one or more traffic flows of one or more monitoring computing devices and/or one or more non-monitoring computing devices. The traffic flow characteristics may include information obtained directly from individual traffic packets (referred to as “intrinsic” characteristics), and information obtained by observing tagged packets over time for patterns in timing, volume, size, etc. of related communication packets (referred to as “extrinsic” characteristics).

Intrinsic characteristics obtained individual packets of a traffic flow include information within the packet headers. Such intrinsic characteristics may include one or more of an identifier (ID) of the computing device sending and/or receiving packets of the traffic flow (e.g., the computing device's MAC ID), a source IP address of the traffic flow, a source port of the traffic flow, a destination IP address of the traffic flow, and a destination port of the traffic flow. Intrinsic information may also include the time that a particular packet is sent via the network. The processor of the network device may determine such intrinsic traffic flow characteristics by performing packet header inspection of packets in the network traffic flows. Inspection of the packet headers may enable the network device to handle both non-encrypted and encrypted network traffic flows in various embodiments.

Extrinsic traffic flow characteristics may be obtained by the processor of the network device by observing tagged packets, and any packets received in response over an observational period of time to identify common features or patterns in such traffic flows. Examples of extrinsic traffic flow characteristics may include one or more of packet size, packet volumes, packet interarrival times, packet lengths, packet length densities, session handshake patterns, messaging patterns, and packet statistics, such as mean packet size, interquartile range (IQR), and decomposition type (Wavelet, Fourier, etc.). In various embodiments, the network device may observe a plurality of packets from a network traffic flow and may perform one or more analyses on the plurality packets to determine one or more traffic flow characteristics.

In various embodiments, a semi-supervised application on the network device may learn to associate such intrinsic and extrinsic traffic flow characteristics with a characterization or description of a network traffic flow and/or particular applications received from monitoring computing devices. In various embodiments, the semi-supervised application may learn to associate traffic flow characteristics of traffic flows with information from the monitoring computing devices (e.g., malicious activity tags, information identifying a source application of a network traffic flow, etc.). In various embodiments, this association of information from the monitoring computing devices with certain network traffic flow characteristics may be achieved using machine learning by observing a large number of network traffic flows over time, as well as information about the network traffic flows provided by the monitoring computing devices.

In various embodiments, the processor of the network device may extend information learned about traffic flows of the monitoring computing devices to characterize and monitor traffic flows of non-monitoring computing devices. Such learned associations may enable a network device to take actions to protect non-monitoring computing devices from malicious activities, to better analyze the sources of network traffic from monitoring and non-monitoring computing devices, and recognized when applications executing on networked computing devices are or have been compromised or taken over by non-benign software.

In some embodiments, the processor of the network device may use the learned associations of traffic flow characteristics and traffic flow characterizations or descriptions associated with a malicious activity tag from monitoring computing devices to recognize non-benign or malicious activity in non-monitoring computing devices based on characteristics within network traffic flows of the non-monitoring computing device. For example, the processor of the network device may associate a non-benign or malicious activity with certain network traffic flow characteristics by matching traffic flow information and a malicious activity tag based on the observed one or more traffic flow characteristics. In various embodiments, such learned associations of network traffic characteristics and non-benign or malicious activities may enable the network device to monitor network traffic flows and identify non-benign or malicious activity of both monitoring and non-monitoring computing devices.

In some embodiments, the processor of the network device may use the learned associations of traffic flow characteristics and traffic flow characterizations or descriptions to associate information identifying a source application with characteristics of associated network traffic flows. In such embodiments, the network device may use the learned associations of the source applications with the traffic flow characteristics to determine the applications associated with network traffic of non-monitoring computing devices. This information may enable the network device to identify the various sources and volumes of network traffic associated with the various applications running on both monitoring and non-monitoring computing devices. This capability may enable the network device to generate more accurate network traffic flow information, including identifying the applications responsible for the traffic flows on the communication network.

In some embodiments, the processor of the network device may use the learned associations of information identifying a source application and network traffic flows to monitor network traffic flows of various applications of both monitoring and non-monitoring computing devices to identify when a source application of a traffic flows is a non-benign or malicious application. In some embodiments, the processor of the network device may use the learned associations of information identifying a source application and network traffic flows to monitor network traffic flows of various applications of both monitoring and non-monitoring computing devices to identify when a source application of a traffic flows is a “compromised” application. A “compromised” application is application software that purports to be non-malicious software, and may perform expected or non-malicious functions, but also includes a non-benign or malicious software component. For example, a legitimate software application may be “hacked” and a non-benign or malicious software component inserted into the legitimate software application. In some embodiments, the network device may recognize that a source application of a monitored network traffic flow has been compromised by recognizing when network flow characteristics deviate from one or more learned network flow characteristics of the application. Various embodiments, enable the network device to monitor network traffic flows of both monitoring and non-monitoring computing devices to detect deviations that may indicate that an application has been compromised.

In various embodiments, the processor of the network device may cluster network traffic flows based at least in part on one or more determined traffic flow characteristics. In this manner, network traffic flows that carry similar data, provide similar services, or exhibit similar temporal or packet size characteristics may be grouped together for analysis. In various embodiments, the processor of the network device may associate a malicious activity tag for one network traffic flow in a cluster of network traffic flows with other (e.g., some other or all other) network traffic flows. In various embodiments, the processor of the network device may associate information identifying the source application of network traffic flows within a cluster of network traffic flows with other network traffic flows. In this manner, network traffic flows for non-monitoring computing devices may be clustered with network traffic flows from monitoring computing devices, and the processor of the network device may reduce hardware and software resources required for monitoring the various network traffic flows in the cluster. In some embodiments, network traffic flows for non-monitoring computing devices may be associated with malicious activity tags and/or information identifying source applications based on the network traffic flows for non-monitoring computing devices being clustered with network traffic flows for monitoring computing devices.

In some embodiments, the clustered network traffic flows may share common traffic flow characteristics. For example, network traffic flows clustered with a network traffic flow associated with a malicious activity tag may also be assumed to be malicious. As another example, network traffic flows clustered with a network traffic flows associated with information identifying a source application may be assumed to also be associated with the same source application.

In various embodiments, the processor of the network device may associate a malicious activity tag and/or information identifying source applications for one network traffic flow in a cluster of network traffic flows with other network traffic flows based at least in part by applying a semi-supervised learning system. The semi-supervised learning system may be a computing device implemented pattern recognition technique that may operate automatically and free of human analyzer input, but that may optionally at times receive human analyzer input to update/modify/add/delete learned patterns.

In various embodiments, the processor of the network device may send an indication of all network traffic flows associated with a malicious activity tag and/or information identifying source applications to another device, such as a security hub managing security for those network traffic flows. The ability to associate network traffic flows for non-monitoring computing devices with network traffic flows labeled by monitoring computing devices with malicious activity tags and/or information identifying source applications may enable the security hub to take actions to handle malicious network traffic flows for non-monitoring computing devices as well as monitoring computing devices. For example, the security hub may be configured to prioritize suspicious network flows for deeper analysis and the prioritization may be based at least in part on any malicious activity tags received by the security hub.

In some embodiments, the security hub may be configured to send malicious activity tags and/or information identifying source applications for network traffic flows to a computing device, such as a monitoring computing device and/or non-monitoring computing device, associated with a suspicious network flow. Sending malicious activity tags and/or information identifying source applications by the security hub to a computing device may enable non-benign or malicious activity to be identified by the computing device, such as a monitoring computing device, even though the computing device's malware database has not been updated to recognize the non-benign or malicious activity.

In some embodiments, a processor of a network device, such as a router, may send malicious activity tags and/or information identifying source applications to all monitoring computing devices clustered with a network traffic flow. Sending malicious activity tags and/or information identifying source applications by the network device to all monitoring computing devices may enable non-benign or malicious activity to be identified by a monitoring computing device even though some or all of the monitoring computing devices' malware database have not been updated to recognize the non-benign or malicious activity identified by the malicious activity tag and/or information identifying source applications.

The enhanced visibility into the various network traffic flows on the network for both monitoring computing devices and non-monitoring computing devices may enable more accurate management of network traffic flows, and may enable more accurate detection of non-benign or malicious activity and more effective protection of computing devices from such non-benign or malicious activity.

Various embodiments provide methods of using information from or related to network traffic flows to identify and/or characterize applications running on computing devices on a communication network. Various embodiments may apply machine learning capabilities to learn associations of characteristics of network traffic flows, characterizations of the network traffic flows, and/or source applications of the network traffic flows. Various embodiments may enable the detection of and protection of computing devices from malicious activity.

Various embodiments may enable the identification of a source of non-benign or malicious activity (such as the originating computing device) even though all computing devices in the network may not be configured to report information such as malicious activity tags and/or information identifying source application to the network device. In various embodiments, a security hub device in the network may manage the security of both monitoring computing devices and non-monitoring computing devices, and may take an action to handle any network traffic flows associated with non-benign or malicious activity providing security for both monitoring computing devices and non-monitoring computing devices. For example, the security hub may be configured to prioritize suspicious network flows for both monitoring computing devices and/or non-monitoring computing devices for deeper analysis, and such prioritization may be based at least in part on any malicious activity tags received by the security hub. Various embodiments may enable both monitoring computing devices and non-monitoring computing devices to be provided security by non-benign or malicious activity reporting from only a subset of computing devices in the network, specifically only non-benign or malicious activity reporting from the monitoring computing devices. For example, various embodiments may enable the detection of zero day exploits, such as novel malware applications are malicious software, despite the presence of non-monitoring computing devices and the network.

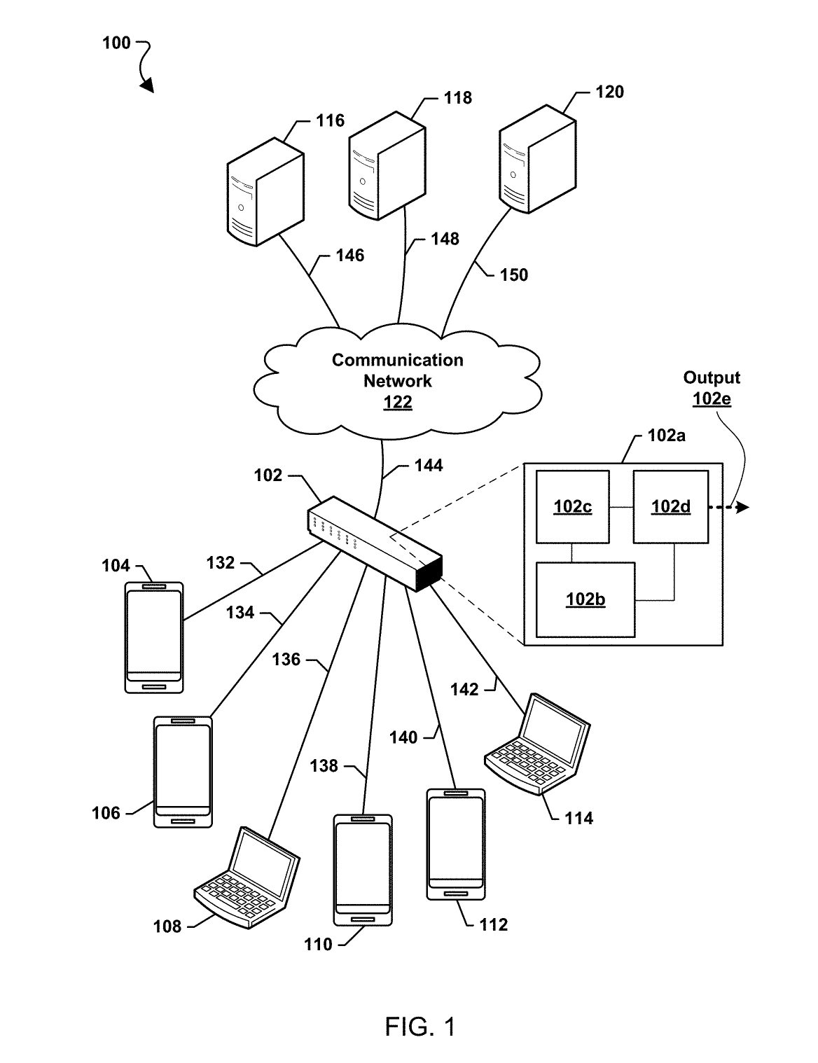

FIG. 1 illustrates a network system 100 suitable for use with various embodiments. The system 100 may include multiple devices, such as servers 116, 118, and 120, and computing devices 104, 106, 108, 110, 112, and 114. The computing devices 104-114 may communicate with a communication network 122 via a network device 102. The network device 102 may forward packets from or to the computing devices 104-114. In some embodiments, the network device 102 may establish a wide area network (WAN) type connection with the communication network 122 via one or more wired and/or wireless communication links 144, which may utilize a communication protocol such as Code Division Multiple Access (CDMA), Time Division Multiple Access (TDMA), Global System for Mobile Communications (GSM), Personal Communication Service (PCS), Third Generation (3G), Fourth Generation (4G), Long Term Evolution (LTE), Broadband Integrated Services Digital Network (B-ISDN), Digital Subscriber Line (DSL), or any other communication protocol. The network device 102 may also establish local area network (LAN) type connections with the computing devices 104-114 via one or more respective wired and/or wireless communication links 132-142, which may employ a communication protocol such as Code Division Multiple Access (CDMA), Time Division Multiple Access (TDMA), Global System for Mobile Communications (GSM), Personal Communication Service (PCS), Third Generation (3G), Fourth Generation (4G), Long Term Evolution (LTE), Bluetooth, Wi-Fi, Ethernet, or any other communication protocol. The network device 102 may communicate establish connections directly with the computing devices 104-114 or may communicate with the computing devices 104-114 indirectly through other devices, such as via base stations, access points, or other similar devices in communication with network device 102. In some embodiments, the network device network device 102 may be an element of a wireless communication network configured to facilitate communication between the computing devices 104-114 and the communication network 122.

The servers and 116-120 may communicate with the communication network 122 over respective communication links 146, 148, 150. The communication links 146, 148, 150 may employ a communication protocol similar to any of the communication protocols described above. The servers and 116-120 and the computing devices 104-114 may communicate information via network device 102 according to one or more transport protocols over the communication network 122. The servers 116-120 may be any type servers, such as web application servers that may host web applications, security hub devices that may manage security for groups of computing devices, such as computing devices 104-114, or any other type servers. Network traffic flows between the servers and 116-120 and computing devices 104-114 may be forwarded by the network device 102 such that the packets of the network traffic flows arrive at the intended destination devices, such as servers 116-120 and computing devices 104-114.

The network device 102 may include a network traffic flow module 102a. The network traffic flow module 102a may include a network traffic monitor 102b, a learning module 102c, and an analyzer module 102d. In various embodiments, the network traffic flow module 102a, the network traffic monitor 102b, the learning module 102c, and the analyzer module 102d may be implemented in the network device 102 in hardware, software, or a combination of hardware and software. In various embodiments, the network traffic flow module 102a may include, or may be a component of, a semi-supervised learning system that may be configured to learn associations of network traffic flow characteristics and information identifying characterizations of the network traffic flows and or characterizations of the source application of a network traffic flow. In various embodiments, each of the network traffic monitor 102b, the learning module 102c, and the analyzer module 102d may include, or may be a component of, the semi-supervised learning system.

One or more of the computing devices 104-114 may be configured to operate as a monitoring computing device that may send information characterizing or identifying a network traffic flow and/or information characterizing or identifying an application of the computing device that is the source of a network traffic flow. For example, a monitoring computing device may be configured to send one or more malicious activity tags to the network device 102. The monitoring computing device may determine whether activities occurring in or during the network traffic flows are normal (or benign) or malicious. Non-benign or malicious activities may include activities causing the leakage of an IMEI of a computing device 104-114, activities tracking a computing device 104-114 location, an unexpected or atypical connection for a particular application or for a particular type of communication, communication with a malicious server, communication activity typically associated with malware, or any other activity that may negatively affect a computing device, a server, or another element of the communication network. In response to detecting non-benign or malicious activities during a network traffic flow, the monitoring computing device may generate a malicious activity tag and send the malicious activity tag to the 102 forwarding the network traffic flow.

In various embodiments, a monitoring computing device (e.g., the computing devices 104-114) may be configured to provide to the network device 102 information identifying a source application of a network traffic flow from the monitoring computing device. For example, a monitoring computing device may provide information identifying a particular application (e.g., a particular streaming media application, messaging application, browsing application, game application, and the like) as the source application of a particular network traffic flow. In some embodiments, a monitoring computing device may provide the information identifying the source application in the packet header of network traffic from the computing device. In some embodiments, a monitoring computing device may provide information identifying a source application in an out of band message to the network device 102.

One or more of the computing devices 104-114 may be a non-monitoring computing device that is not configured to send information to the network device 102 beyond the minimum information associated with network communications. Thus, the network device 102 will receive little or no information from non-monitoring computing devices 104-114 characterizing or identifying a network traffic flow and/or information characterizing or identifying an application that is the source of a network traffic flow. In various embodiments, a portion of the computing devices 104-114 may be configured to operate as monitoring computing devices while another portion of the computing devices 104-114 may be non-monitoring computing devices (i.e., not configured to operate as monitoring computing devices).

In various embodiments, the processor of the network device 102 (e.g., the network traffic monitor 102b) may determine one or more characteristics of a traffic flow from the computing devices 104-114, such as one or more traffic flows of one or more monitoring computing devices and/or one or more non-monitoring computing devices. The traffic flow characteristics may include information from the packet header of a traffic flow, such as one or more of an identifier (ID) of the computing device sending and/or receiving packets of the traffic flow (e.g., the computing device's MAC ID), a source IP address of the traffic flow, a source port of the traffic flow, a destination IP address of the traffic flow, and a destination port of the traffic flow. The processor of the network device 102 may determine such traffic flow characteristics by performing packet header inspection of packets in the network device. Inspection of the packet headers may enable the network device to handle both non-encrypted and encrypted network traffic flows in various embodiments.

In various embodiments, the traffic flow characteristics may include one or more behaviors, characteristics, or features of the network traffic flows. In various embodiments, traffic flow features that may be determined by the processor of the network device 102 may include one or more of packet size, packet volumes, packet interarrival times, destination addresses, destination ports, packet lengths, packet length densities, session handshake patterns, messaging patterns, packet statistics (e.g., mean packet size, interquartile range (IQR), and decomposition type (Wavelet, Fourier, etc.)). In some embodiments, the network device may receive a plurality of packets from a network traffic flow and may perform one or more analyses on the plurality packets to determine one or more traffic flow characteristics.

In various embodiments, a semi-supervised application on the network device 102 (e.g., learning module 102c) may learn to associate traffic flow characteristics of traffic flows with a characterization or description of a network traffic flow and/or particular applications. In various embodiments, the semi-supervised application may learn to associate traffic flow characteristics of traffic flows with information from the monitoring computing devices (e.g., malicious activity tags, information identifying a source application of a network traffic flow, etc.). In various embodiments, this association of information from the monitoring computing devices with certain network traffic flow characteristics may be achieved using machine learning by observing a large number of network traffic flows as well as information about the network traffic flows provided by the monitoring computing devices.

In various embodiments, the processor of the network device 102 (e.g., the analyzer module 102d) may extend information about traffic flows of the monitoring computing devices that is determined and/or received by the network device 102 to characterize and monitor traffic flows of non-monitoring computing devices. In some embodiments, the processor of the network device 102 (e.g., the analyzer module 102d) may use the learned associations of traffic flow characteristics and traffic flow characterizations or descriptions (e.g., learned by the learning module 102c) to associate a malicious activity tag with a network traffic flow of a non-monitoring computing device. For example, the processor of the network device 102 may associate a malicious activity tag with a network traffic flow by matching traffic flow information and a malicious activity tag, based on one or more traffic flow characteristics. In some embodiments, the processor of the network device 102 may be configured to recognize non-benign or malicious activity of non-monitoring computing devices by recognizing patterns in network traffic learned by observing network traffic flows including malicious activity tags received from monitoring computing devices. In various embodiments, this information may enable the network device to monitor network traffic flows and identify non-benign or malicious activity of both monitoring and non-monitoring computing devices. In various embodiments, the network traffic flow module 102a may provide as an output 102e the learned associations of traffic flow characteristics and traffic flow characterizations or descriptions, associations of a malicious activity tag with a network traffic flow of a monitoring and/or non-monitoring computing device, and other information.

In some embodiments, the processor of the network device 102 (e.g., the analyzer module 102d) may use the learned associations of traffic flow characteristics and traffic flow characterizations or descriptions to associate information identifying a source application with a network traffic flow. In some embodiments, the network device 102 may use the learned association of the source applications with the traffic flow characteristics to determine applications associated with network traffic of non-monitoring computing devices. This information may enable the network device 102 to identify the various sources and volumes of traffic associated with the various applications running on both monitoring and non-monitoring computing devices, which may enable the network device 102 to generate more accurate network traffic flow information, including identifying the applications responsible for the traffic flows on the communication network. In various embodiments, the network traffic flow module 102a may provide as the output 102e the learned associations of the source applications with the traffic flow characteristics, the identification of the various sources and volumes of traffic, the more accurate network traffic phone information, and other information.

In some embodiments, the processor of the network device 102 may use the learned associations of information identifying a source application and network traffic flows to monitor network traffic flows of various applications of both monitoring and non-monitoring computing devices to identify when a source application of a traffic flows is a malicious application. In some embodiments, the processor of the network device 102 may use the learned associations of information identifying a source application and network traffic flows to monitor network traffic flows of various applications of both monitoring and non-monitoring computing devices to identify when a source application of a traffic flows is a “compromised” application.

In various embodiments, the processor of the network device 102 may cluster network traffic flows of the computing devices 104-114 based at least in part on one or more determined traffic flow characteristics. In this manner, network traffic flows that carry similar data or provide similar services may be grouped together. In various embodiments, the processor of the network device 102 may associate a malicious activity tag for one network traffic flow in a cluster of network traffic flows with other (e.g., some other or all other) network traffic flows. In various embodiments, the processor of the network device 102 may associate information identifying the source application of network traffic flow in a cluster of network traffic flows with other network traffic flows. In this manner, network traffic flows for non-monitoring computing devices may be clustered with network traffic flows from monitoring computing devices, and the processor of the network device 102 may reduce hardware and software resources required for monitoring the various network traffic flows in the cluster. In some embodiments, network traffic flows for non-monitoring computing devices may be associated with malicious activity tags and/or information identifying source applications based on the network traffic flows for non-monitoring computing devices being clustered with network traffic flows for monitoring computing devices.

In some embodiments, the clustered network traffic flows may share common traffic flow characteristics. For example, network traffic flows clustered with a network traffic flow associated with a malicious activity tag may also be assumed to be malicious. As another example, network traffic flows clustered with a network traffic flows associated with information identifying a source application may be assumed to also be associated with the same source application. In various embodiments, the processor of the network device 102 may associate a malicious activity tag and/or information identifying source applications for one network traffic flow in a cluster of network traffic flows with other network traffic flows based at least in part by applying a semi-supervised learning system (e.g., the network traffic flow module 102a, the network traffic monitor 102b, the learning module 102c, and/or the analyzer module 102d). The semi-supervised learning system may be a computing device-implemented pattern recognition technique that may operate automatically, free of human analyzer input. In some embodiments, the semi-supervised learning system may at times receive human analyzer input to update/modify/add/delete learned patterns.

In various embodiments, the processor of the network device 102 may send an indication of all network traffic flows associated with a malicious activity tag and/or information identifying source applications to another device, such as a security hub managing security for those network traffic flows. In some embodiments, the security hub may be a component of the network device 102. In some embodiments, the security hub may be another element of the communication system 100.

The ability to associate network traffic flows from non-monitoring computing devices with malicious activity tags and/or information identifying source applications based on the network traffic flows for non-monitoring computing devices may enable the security hub to recognize and take actions to handle malicious network traffic flows from non-monitoring computing devices. For example, the security hub may be configured to prioritize suspicious network flows for deeper analysis and the prioritization may be based at least in part on any malicious activity tags received by the security hub. As another example, the security hub may be configured to send malicious activity tags and/or information identifying source applications for network traffic flows to a computing device, such as a monitoring computing device and/or non-monitoring computing device, associated with a suspicious network flow. The sending of malicious activity tags and/or information identifying source applications by the security hub may enable non-benign or malicious activity to be identified by a computing device, such as a monitoring computing device, even though the computing device's malware database has not been updated to recognize the non-benign or malicious activity. In various embodiments, a processor of a network device, such as a router, may send malicious activity tags and/or information identifying source applications to all monitoring computing devices clustered with a network traffic flow. Sending malicious activity tags and/or information identifying source applications by the network device to a monitoring computing device may enable malicious activity to be identified by the monitoring computing device even though the monitoring computing device's malware database has not been updated to recognize the non-benign or malicious activity identified by the malicious activity tag and/or information identifying source applications.

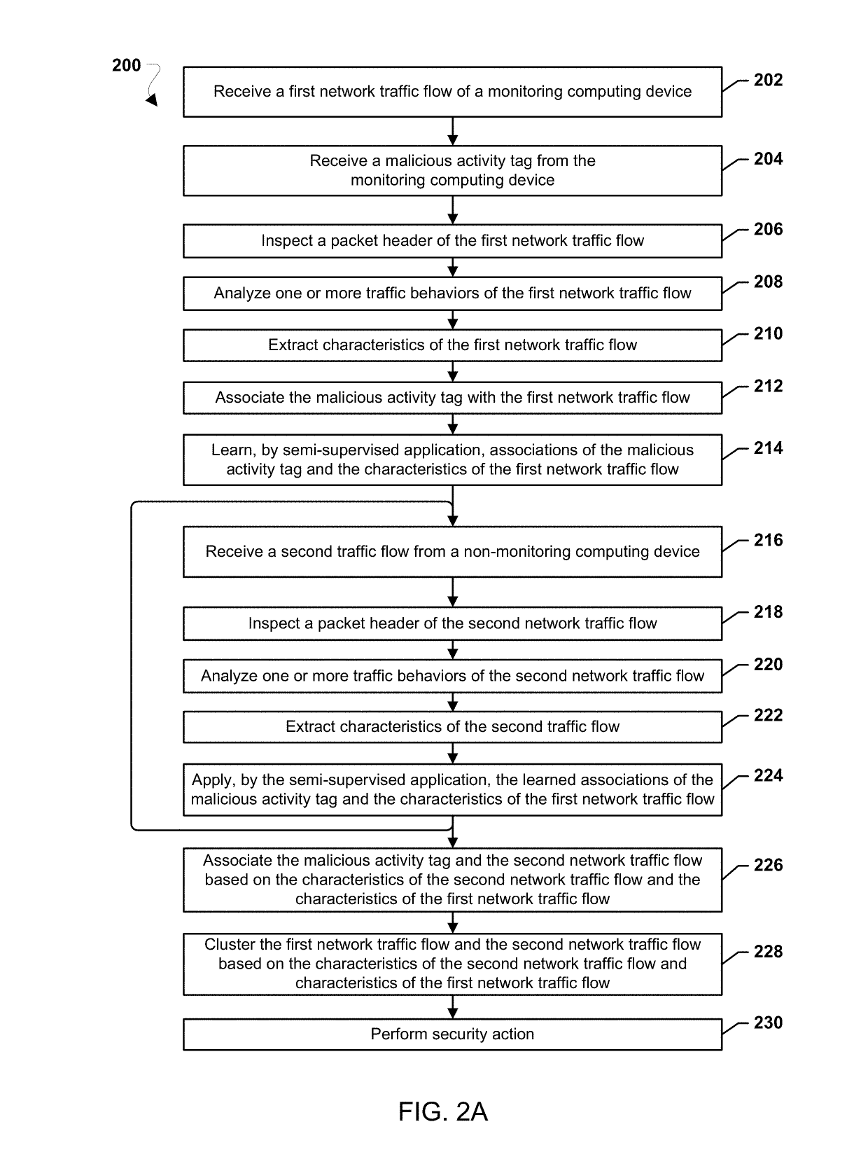

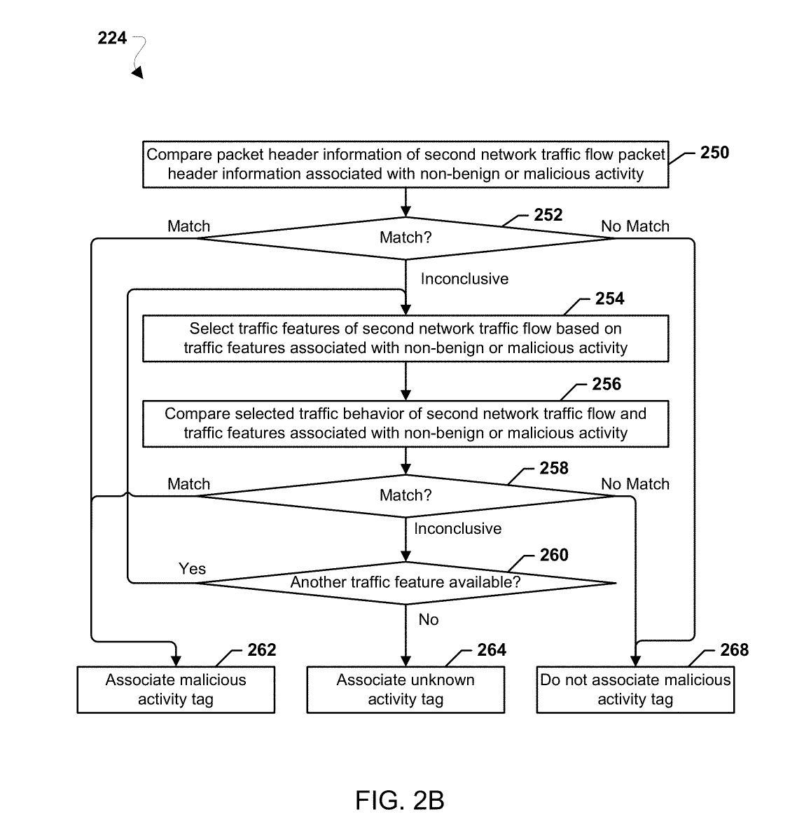

FIG. 2A illustrates a method 200 for protecting computing devices from non-benign or malicious activity according to various embodiments. With reference to FIGS. 1-2A, the method 200 may be implemented by a processor of a network device 102.

In block 202, the processor of the network device 102 may receive a first network traffic flow for a monitoring computing device. For example, the processor of the network device 102 may receive the first network traffic flow to and/or from one of the computing devices 104-114 that is configured to operate as a monitoring computing device.

In block 204, the processor of the network device 102 may receive a malicious activity tag from the monitoring computing device. The malicious activity tag may indicate or describe behavior of the network traffic flow identified or detected by the monitoring computing device 104-114. The identified behavior may be malicious or non-malicious. The malicious activity tag may indicate information about the network traffic flows on which malicious activities occurred. The indications in the malicious activity tag may enable a network device, such as a router, receiving the malicious activity tag to associate the malicious activity tag with a network traffic flow. Example indications of types of malicious activities may include “IMEI leakage,” “location tracking,” “unexpected connection,” or any other indication. In some embodiments, malicious activity tags may be sent in an out of band message, such as an overhead signaling message, from a monitoring computing device to the network device. In various embodiments, malicious activity tags may indicate a type of non-benign or malicious activity that was detected by the monitoring computing device 104-114.

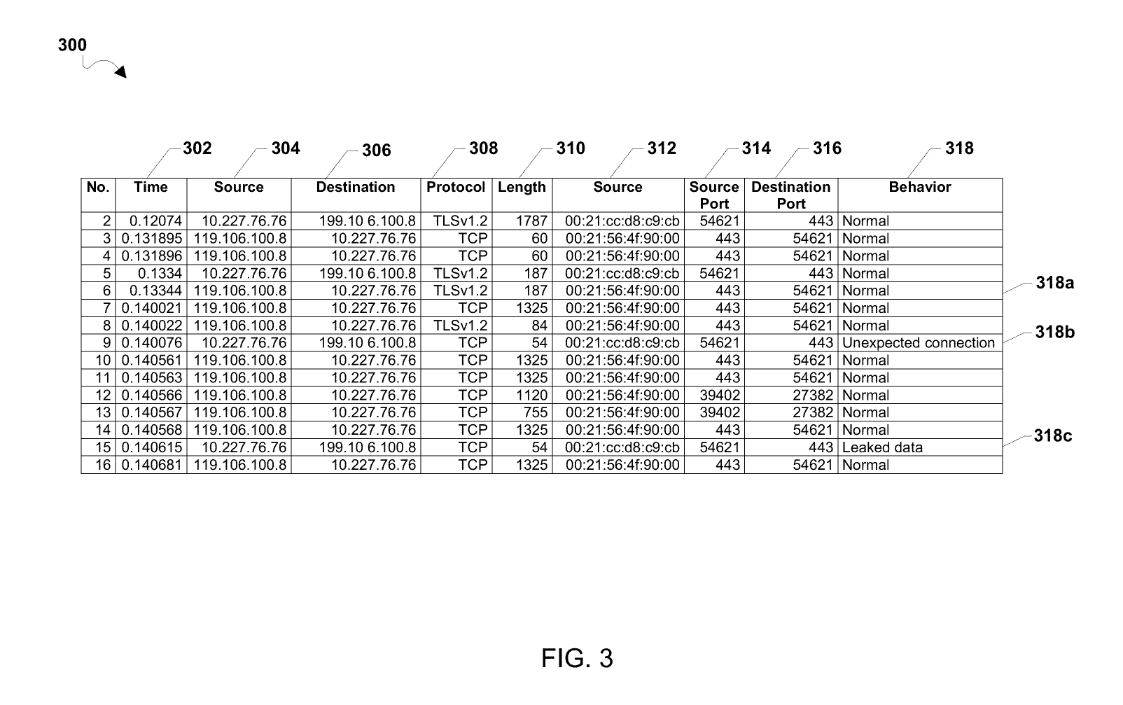

The processor of the network device 102 may determine one or more characteristics of a traffic flow from a computing device, such as one or more traffic flows of one or more monitoring computing devices 104-114 and/or one or more non-monitoring computing devices. In block 206, the processor of the network device 102 may inspect the packet header of the first network traffic flow to observe intrinsic traffic flow characteristics of individual packets within the flow. The intrinsic traffic flow characteristics may include information from the packet header of a traffic flow, such as one or more of an identifier (ID) of the computing device sending and/or receiving packets of the traffic flow (e.g., the computing device's MAC ID), a source IP address of the traffic flow, a source port of the traffic flow, a destination IP address of the traffic flow, and a destination port of the traffic flow. The processor of the network device 102 may determine such intrinsic traffic flow characteristics by performing packet header inspection of packets in the network traffic flows. Inspection of the packet headers may enable the network device to handle both non-encrypted and encrypted network traffic flows in various embodiments. In various embodiments, the processor of the network device 102 may inspect packet headers of non-encrypted and/or encrypted network traffic flows. In some embodiments, the processor of the network device 102 may store packet header information in a data structure configured to enable rapid access to the various packet header data, as further described with reference to traffic flow characteristics 300 illustrated in FIG. 3.

In block 208, the processor of the network device 102 may analyze a plurality of packets of the first network traffic flow for one or more extrinsic traffic characteristics. In various embodiments, extrinsic traffic flow characteristics may include one or more behaviors, characteristics, or features of the network traffic flows. In various embodiments, extrinsic traffic flow characteristics that may be determined by the processor of the network device 102 in block 208 may include one or more of packet size, packet volumes, packet interarrival times, packet lengths, packet length densities, session handshake patterns, messaging patterns, and packet statistics (e.g., mean packet size, interquartile range (IQR), and decomposition type (Wavelet, Fourier, etc.)).

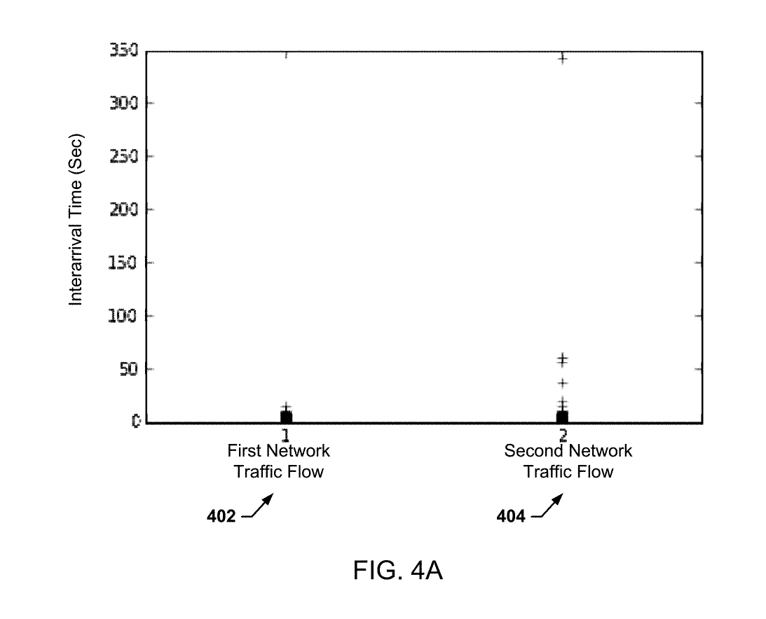

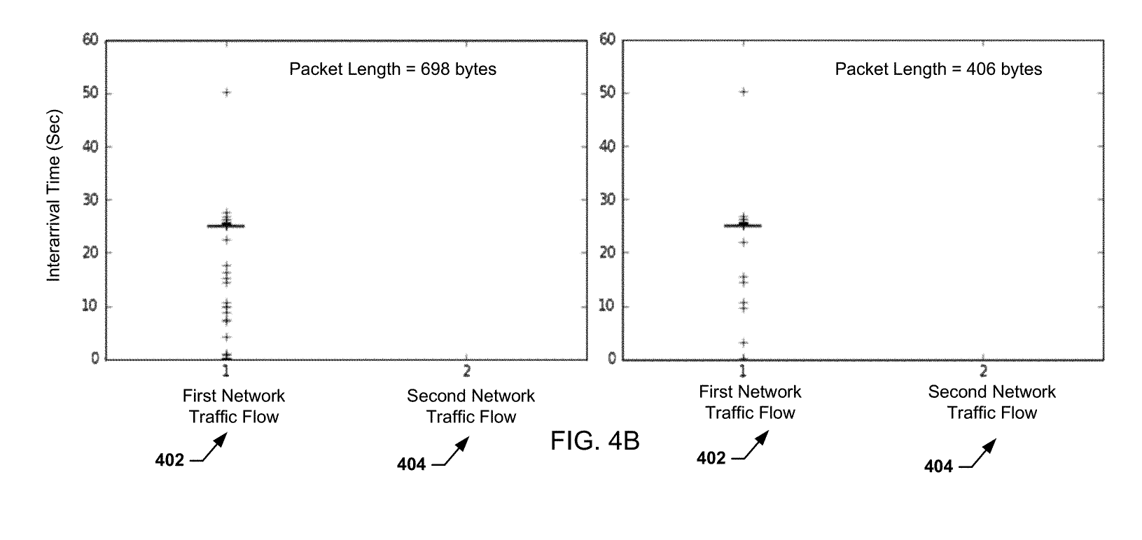

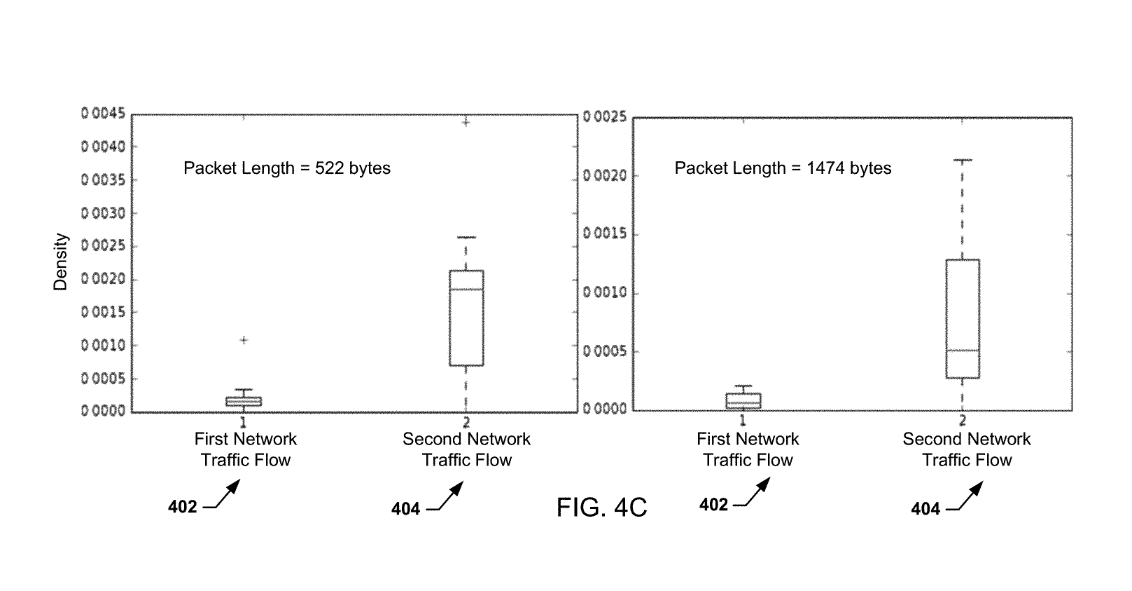

In block 210, the processor of the network device 102 may extract the characteristics of the first network traffic flow. In some embodiments, the extracted characteristics of the first network traffic flow may include both intrinsic characteristics obtained from the inspection of packet headers of packets in the first network traffic flow, and extrinsic characteristics obtained from the analysis of the one or more traffic patterns observable within the first network traffic flow. FIGS. 4A, 4B, and 4C illustrate examples of extrinsic characteristics or features of the network traffic flows that may be observed and extracted by the processor in block 210. As further described, the extrinsic traffic flow characteristics illustrated in FIGS. 4A, 4B, and 4C may be used singularly, or in combinations, and may enable network traffic flows to be compared with one another based on common traffic flow features or distinguished from one another based on different traffic flow features.

In block 212, the processor of the network device 102 may associate the malicious activity tag with the first network traffic flow. For example, the processor may associate the malicious activity tag with the network traffic flow for which the malicious activity tag was generated. In various embodiments, the processor of the network device 102 may associate the malicious activity tag received from the monitoring computing device with the network traffic flow for which the monitoring computing device generated the malicious activity tag. In some embodiments, the processor of the network device 102 may associate the malicious activity tag with one or more characteristics of the first network traffic flow extracted in block 210.

In block 214, a semi-supervised application may learn the associations of the malicious activity tag and the characteristics of the first network traffic flow. In various embodiments, the semi-supervised application on the network device may learn to associate traffic flow characteristics of traffic flows with the malicious activity tag. In various embodiments, this association of the malicious activity tag with certain network traffic flow characteristics may be achieved using machine learning by observing a large number of network traffic flows in combination with information about the network traffic flows provided by the monitoring computing devices.

In block 216, the processor of the network device 102 may receive a second traffic flow from a non-monitoring computing device.

In block 218, the processor of the network device 102 may inspect packet headers of the second network traffic flow. In various embodiments, the operations of block 218 may be similar to the operations of block 206.

In block 220, the processor of the network device 102 may analyze one or more traffic features of the second network traffic flow. In various embodiments, the operations of block 220 may be similar to the operations of block 208.

In block 222, the processor of the network device 102 may extract characteristics of the second traffic flow. In some embodiments, the extracted characteristics of the second network traffic flow may be based on one or more of the inspection of a packet header of the second network traffic flow and/or an analysis of one or more traffic behaviors of the second network traffic flow.

In block 224, the semi-supervised learning application may determine whether the extracted characteristics of the second traffic flow match or are substantially similar to the learned associations of the malicious activity tag and the characteristics of the first network traffic flow.

In block 226, the processor of the network device 102 may associate the malicious activity tag and the second network traffic flow if the characteristics of the second network traffic flow match or are similar to the learned characteristics of the first network traffic flow. In some embodiments, the processor of the network device 102 may associate the malicious activity tag in the first network traffic flow with the second network traffic flow when there is a match or substantial similarity between the flows in the learned associations.

In block 228, the processor of the network device 102 may cluster the first network traffic flow and the second network traffic flow based on the characteristics of the second network traffic flow and the characteristics of the first network traffic flow. In this manner, the processor of the network device 102 may group together network traffic flows that carry similar data or provide similar services. In various embodiments, the processor of the network device 102 may associate a malicious activity tag for one network traffic flow in a cluster of network traffic flows with other (e.g., some other or all other) network traffic flows. Clustering network traffic flows for non-monitoring computing devices with network traffic flows from monitoring computing devices may reduce hardware and software resources required for monitoring the various network traffic flows in the cluster. In some embodiments, network traffic flows for non-monitoring computing devices may be associated with malicious activity tags and/or information identifying source applications based on the network traffic flows for non-monitoring computing devices being clustered with network traffic flows for monitoring computing devices.

In some embodiments, the clustered network traffic flows may share common traffic flow characteristics. For example, network traffic flows clustered with a network traffic flow associated with a malicious activity tag may also be assumed to be malicious. As another example, network traffic flows clustered with network traffic flows associated with information identifying a source application may be assumed to also be associated with the same source application. In various embodiments, the processor of the network device 102 may associate a malicious activity tag and/or information identifying source applications for one network traffic flow in a cluster of network traffic flows with other network traffic flows based at least in part by applying a semi-supervised learning system. The semi-supervised learning system may be a computing device-implemented pattern recognition technique that may operate automatically and free of human analyzer input, but that may optionally at times receive human analyzer input to update/modify/add/delete learned patterns.

In block 230, the processor of the network device 102 may perform a security action. For example, the processor of the network device 102 may send an indication of all network traffic flows associated with a malicious activity tag and/or information identifying source applications to another device, such as a security hub managing security for those network traffic flows. As network traffic flows for non-monitoring computing devices may be associated with malicious activity tags and/or information identifying source applications based on the network traffic flows for non-monitoring computing devices being clustered with network traffic flows for monitoring computing devices, in various embodiments the security hub may be able to take actions to handle non-benign or malicious network traffic flows for non-monitoring computing devices, as well as monitoring computing devices. For example, the security hub may be configured to prioritize suspicious network flows for deeper analysis and the prioritization may be based at least in part on any malicious activity tags received by the security hub. As another example, the security hub may be configured to send information regarding identified or suspected non-benign or malicious activity associated with a suspicious network flow to a computing device, such as a monitoring computing device and/or non-monitoring computing device, which may enable the receiving computing device (e.g., a monitoring computing device) to identify malicious activity regardless of whether a malware database on the computing device has been updated to recognize the malicious activity. In some embodiments, a processor of a network device 102, such as a router, may send malicious activity tags to all monitoring computing devices having network traffic within the clustered network traffic flow. Sending malicious activity tags and/or information identifying source applications by the network device 102 to all monitoring computing devices may enable non-benign or malicious activity to be identified by monitoring computing devices even though the monitoring computing devices' malware database has not been updated to recognize the non-benign or malicious activity identified by the malicious activity tag.

FIG. 2B illustrates an example of operations that may be performed as part of block 224 of the method 200. With reference to FIGS. 1-2B, the operations of block 224 may be implemented by a processor of a network device 102.

In block 250, the processor of the network device 102 may compare packet header information of the second network traffic flow with packet header information that has been associated with non-benign or malicious activity by observing packet headers of the first network traffic flow. The compared packet header information may include one or more of an identifier (ID) of the computing device sending and/or receiving packets of the traffic flow (e.g., the computing device's MAC ID), a source IP address of the traffic flow, a source port of the traffic flow, a destination IP address of the traffic flow, and a destination port of the traffic flow. The processor of the network device 102 may compare the packet header information rapidly, which may enable the processor of the network device 102 to quickly make an initial determination regarding the comparison.

In determination block 252, the processor of the network device 102 may determine whether the packet header information of the second network traffic flow matches or correlates to packet header information that has been associated with non-benign or malicious activity. In some embodiments, the processor may determine whether the packet header information matches packet header information associated with non-benign or malicious activity. In some embodiments, the processor may determine whether the packet header information correlates to (i.e., is similar to or has aspects in common with) packet header information associated with non-benign or malicious activity within one or more ranges, thresholds, or other criteria. Thus, the processor need not require an exact match of any information in the packet headers of the first and second network traffic flows.

In response to determining that the packet header information of the second network traffic flow matches or correlates to packet header information associated with non-benign or malicious activity (i.e., determination block 252=“Match”), the processor of the network device 102 may associate a malicious activity tag with the second network traffic flow in block 262.

In response to determining that the packet header information of the second network traffic flow does not match or correlate to packet header information associated with non-benign or malicious activity (i.e., determination block 252=“No Match”), the processor of the network device 102 may not associate the malicious activity tag with the second network traffic flow in block 268.

However, the processor of the network device 102 may be unable to make a clear determination regarding whether the packet header information of second network traffic flows matches or correlates to packet header information associated with non-benign or malicious activity. In response to determining that the comparison is inconclusive (i.e., determination block 252=“Inconclusive”), the processor of the network traffic device may select a traffic feature of the second network traffic flow to observe based on a traffic feature associated with non-benign or malicious activity in block 254. For example, the processor of the network device 102 may observe the second network traffic flow over time to obtain interarrival times for related packets.

In block 256, the processor of the network device 102 may compare the selected traffic feature of the second network traffic flow with the selected traffic feature associated with non-benign or malicious activity. For example, the processor of the network device 102 may compare interarrival times of related packets in the second network traffic flow to a range of interarrival times that the network device 102 has associated with a particular non-benign or malicious activity.

In operation, comparison of observable features of network traffic flows to traffic features associated with non-benign or malicious activity may require processing time, because the processor of the network device 102 receives numerous packets of the second traffic flows in order to observe and recognize various traffic flow characteristics that are time dependent (e.g., interarrival times, frequency, volume, etc.). As described, traffic flow characteristics that may be determined by the processor of the network device 102 may include one or more of packet size, packet volumes, interarrival times of packets, packet lengths, packet length densities, session handshake patterns, messaging patterns, packet statistics (e.g., mean packet size, interquartile range (IQR), and decomposition type (Wavelet, Fourier, etc.)).

In determination block 258, the processor of the network device 102 may determine whether the selected traffic feature of the second network traffic flow matches or correlates to the selected traffic feature associated with non-benign or malicious activity. In some embodiments, the processor may determine whether the selected traffic feature of the second network traffic flow matches the selected traffic feature of the second network traffic flow associated with non-benign or malicious activity. In some embodiments, the processor may determine whether the selected traffic feature of the second network traffic flow correlates to (i.e., is similar to or has aspects in common with) the selected traffic feature of the second network traffic flow associated with non-benign or malicious activity within one or more ranges, thresholds, or other criteria.

In determination block 258, the processor may evaluate multiple traffic features in the second traffic flow that have been associated with non-benign or malicious activity, as well as intrinsic characteristics, to determine whether a combination of traffic features and characteristics correlate (i.e., are similar enough) to packet header information and traffic features and characteristics associated with non-benign or malicious activity (e.g., within a threshold level of similarity or probability) to warrant classification as non-benign or malicious. This determination 258 may compare a degree of correlation between the packet header information and a combination of traffic features of the second traffic flow with packet header information and traffic features and characteristics associated with non-benign or malicious activity to a threshold degree of correlation.

In response to determining that the selected traffic feature of the second network traffic flow matches the selected traffic feature associated with non-benign or malicious activity (i.e., determination block 258=“Match”), the processor of the network device 102 may associate the malicious activity tag with the second network traffic flow in block 262.

In response to determining that the selected traffic feature of the second network traffic flow does not match the selected traffic feature associated with non-benign or malicious activity (i.e., determination block 258=“No Match”), the processor of the network device 102 may not associate the malicious activity tag with the second network traffic flow in block 268.

However, the processor of the network device 102 may be unable to make a clear determination regarding whether the selected traffic feature of the second network traffic flow matches the selected traffic behavior of the first network traffic flow. In response to determining that the comparison is inconclusive (i.e., determination block 258=“Inconclusive”), the processor of the network traffic device may determine whether another traffic feature associated with non-benign or malicious activity is available for comparison in determination block 260.

In response to determining that another traffic feature associated with non-benign or malicious activity is available for comparison (i.e., determination block 260=“Yes”), the processor of the network device 102 may select another traffic feature to be observed in the second network traffic flow and compared to a traffic feature associated with non-benign or malicious activity in block 254.

In response to determining that another traffic feature associated with non-benign or malicious activity is not available for comparison (i.e., determination block 260=“No”), the processor of the network device 102 may associate with the second network traffic flow a tag indicating that it is unknown whether the activity of the second network traffic flow is benign/non-malicious or non-benign/malicious in block 264.

FIG. 3 is an example of intrinsic traffic flow characteristics 300 according to some embodiments. With reference to FIGS. 1-3, a processor of a network device 102 may inspect packet headers of the first and/or second network traffic flows to extract the traffic flow characteristics 300. In some embodiments, the processor may store the traffic flow characteristics 300 in a memory of the network device available to the processor. In some embodiments, the processor may cluster packet header information by recording the number of packets observed within a traffic flow having packet header information of a particular type (e.g., particular destination address, port number, etc.).

In some embodiments, the traffic flow characteristics 300 may include a time stamp 302 of each packet, a source 304 of the network traffic, a destination 306 of the network traffic, a protocol 308 of the network traffic, a packet length 310 of the network traffic, a source device ID 312 of the network traffic, a source port 314 of the network traffic, and a destination port 316 of the network traffic. A monitoring computing device may include within packet headers an indicator of a type (or behavior) 318 of the activity, such as a malicious activity tag identifying a type of non-benign or malicious activity. Example indications of types of non-benign or malicious activities may include “IMEI leakage”, “location tracking”, “unexpected connection”, or any other indication. Further examples of types of non-benign or malicious activities 318 that may be indicated include “normal” 318a, “unexpected connection” 318b, and “leaked data” 318c.

FIGS. 4A, 4B, and 4C illustrate plots of various extrinsic traffic flow characteristics that may be observable within a first network traffic flow and a second network traffic flow. The various extrinsic traffic flow characteristics illustrated in

FIGS. 4A, 4B, and 4C may enable a processor to distinguish a first service from second service, or relate two different traffic flows to one another based on observable traffic flow features.

FIG. 4A illustrates a plot of packet interarrival times for a first network traffic flow 402 of a first service, for example, a YouTube video, and a second network traffic flow 404 of a second service, for example, a Vimeo video. As shown in FIG. 4A, the two different services exhibit recognizably different interarrival time patterns. For example, the first network traffic 402 flow exhibits little variance in interarrival times, while the second network traffic 404 flow exhibits interarrival times ranging from a few seconds to over a minute. FIG. 4A also illustrates that a single observable traffic flow feature, such as packet interarrival time, may not distinguish or associate the first network traffic flow and the second network traffic flow sufficiently from/with one another. For example, an interarrival time of very few seconds is consistent with both the first and second traffic flows 402, 404.

However, when packet interarrival time and packet lengths are used together as network traffic features, the distinction may be more pronounced, as illustrated in FIG. 4B. Using interarrival times of packets with a packet length of 698 bytes or a packet length of 406 bytes separates the first network traffic flow from the second network traffic flow as shown in the comparison plots in FIG. 4B. Thus, using two traffic flow features (e.g., interarrival time and packet length) may enable traffic flows to be distinguished or related to one another.

As an alternate traffic flow feature, instead of interarrival times for a single packet size, the interarrivals for a range of packet sizes may be used. FIG. 4C illustrates comparison plots of packet densities that may be used as traffic flow features to associate or distinguish network traffic flows. Packet densities may be determined for packet lengths of different sizes, such as 522 bytes or 1474 bytes, and the relative densities of packets of that length may distinguish the first network traffic flow from the second network traffic flow, as the second network traffic flow may have a larger density of such packet sizes. Interarrival time, packet length, and packet densities are merely examples of traffic flow features that may be used to identify associated network traffic flows and any other traffic flow features may be used singularly, or in combination, in various embodiments to enable network traffic flows to be clustered together.

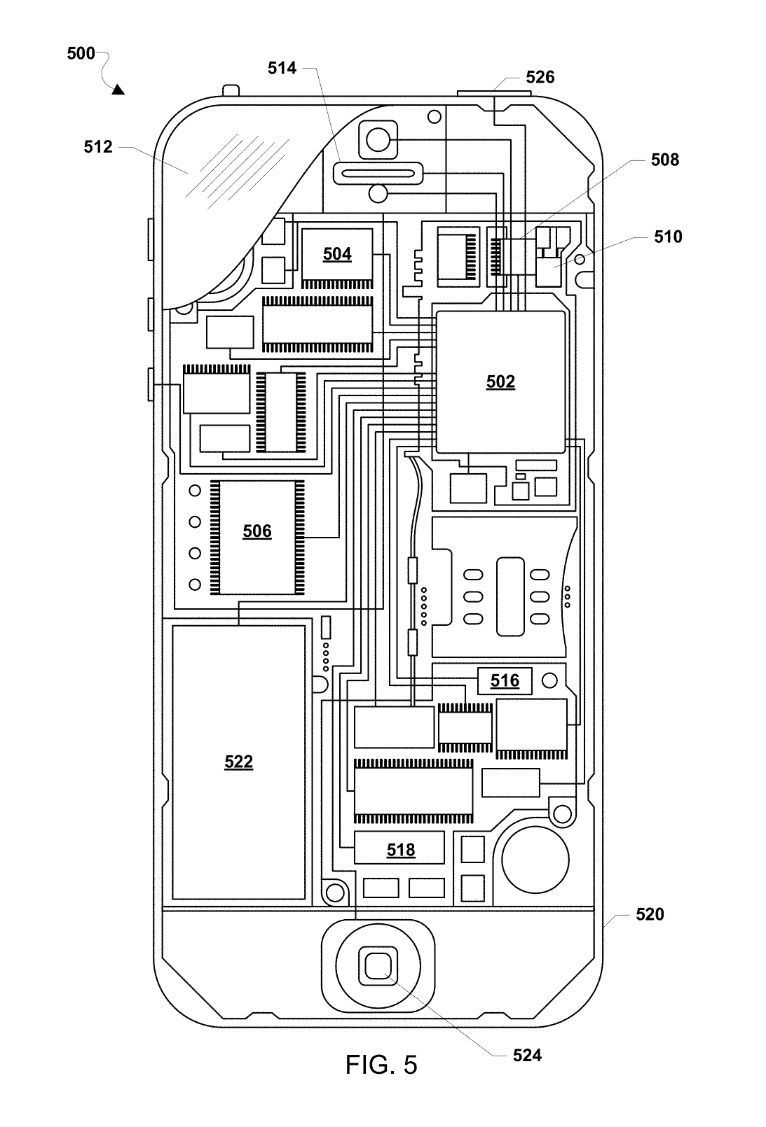

Various embodiments (including, but not limited to, embodiments described above with reference to FIGS. 1-4C) may be implemented in any of a variety of mobile computing devices, an example of which (e.g., mobile computing device 500) is illustrated in FIG. 5. With reference to FIGS. 1-5, the mobile computing device 500 may be similar to the computing devices 104-114, the network device 102, and the servers 116-120. As such, the mobile computing device 500 may implement the method 200 of FIG. 2A.

The mobile computing device 500 may include a processor 502 coupled to a touchscreen controller 504 and an internal memory 506. The processor 502 may be one or more multi-core integrated circuits designated for general or specific processing tasks. The internal memory 506 may be volatile or non-volatile memory, and may also be secure and/or encrypted memory, or unsecure and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the mobile computing device 500 need not have touch screen capability.

The mobile computing device 500 may have two or more radio signal transceivers 508 (e.g., Peanut, Bluetooth, Zig Bee, Wi-Fi, etc.) and antennae 510, for sending and receiving communications, coupled to each other and/or to the processor 502. The transceivers 508 and antennae 510 may be used with the above-mentioned circuitry to implement the various wireless transmission protocol stacks and interfaces. The mobile computing device 500 may include one or more cellular network wireless modem chip(s) 516 coupled to the processor and antennae 510 that enable communication via two or more cellular networks via two or more radio access technologies.

The mobile computing device 500 may include a peripheral device connection interface 518 coupled to the processor 502. The peripheral device connection interface 518 may be singularly configured to accept one type of connection, or may be configured to accept various types of physical and communication connections, common or proprietary, such as USB, FireWire, Thunderbolt, or PCIe. The peripheral device connection interface 518 may also be coupled to a similarly configured peripheral device connection port (not shown).

The mobile computing device 500 may also include speakers 514 for providing audio outputs. The mobile computing device 500 may also include a housing 520, constructed of a plastic, metal, or a combination of materials, for containing all or some of the components discussed herein. The mobile computing device 500 may include a power source 522 coupled to the processor 502, such as a disposable or rechargeable battery. The rechargeable battery may also be coupled to the peripheral device connection port to receive a charging current from a source external to the mobile computing device 500. The mobile computing device 500 may also include a physical button 524 for receiving user inputs. The mobile computing device 500 may also include a power button 526 for turning the mobile computing device 500 on and off.

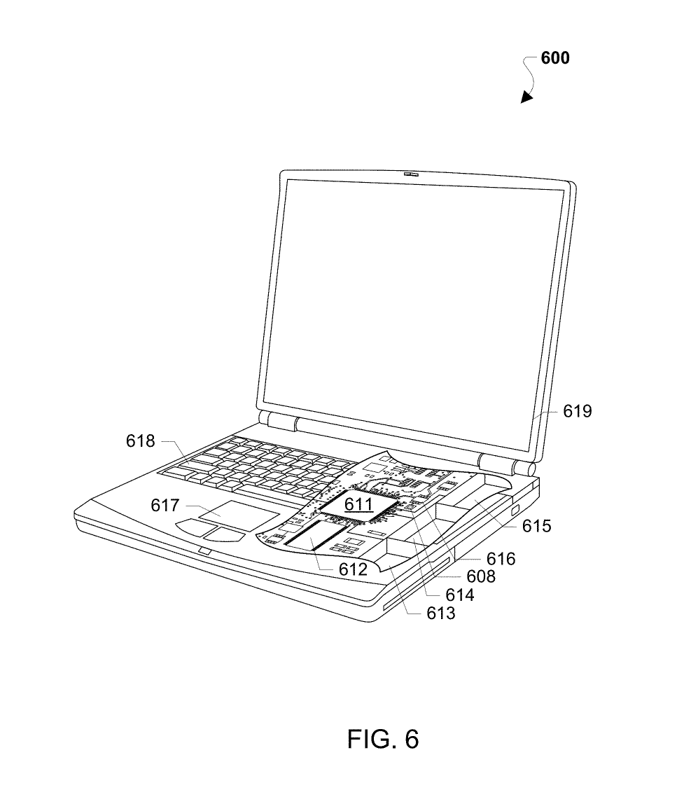

Various embodiments (including, but not limited to, embodiments described above with reference to FIGS. 1-4C) may be implemented in a wide variety of computing devices include a laptop computer 600 an example of which is illustrated in FIG. 6. With reference to FIGS. 1-6, the laptop computer 600 may be similar to the computing devices 104-114, the network device 102, and the servers 116-120. As such, the laptop computer 600 may implement the method 200.

Many laptop computers include a touchpad touch surface 617 that serves as the computer's pointing device, and thus may receive drag, scroll, and flick gestures similar to those implemented on computing devices equipped with a touch screen display and described above. A laptop computer 600 will typically include a processor 611 coupled to volatile memory 612 and a large capacity nonvolatile memory, such as a disk drive 613 of Flash memory. Additionally, the computer 600 may have one or more antenna 608 for sending and receiving electromagnetic radiation that may be connected to a wireless data link and/or cellular telephone transceiver 616 coupled to the processor 611. The computer 600 may also include a floppy disc drive 614 and a compact disc (CD) drive 615 coupled to the processor 611. In a notebook configuration, the computer housing includes the touchpad 617, the keyboard 618, and the display 619 all coupled to the processor 611. Other configurations of the computing device may include a computer mouse or trackball coupled to the processor (e.g., via a Universal Serial Bus (USB) input) as are well known, which may also be used in conjunction with various embodiments.

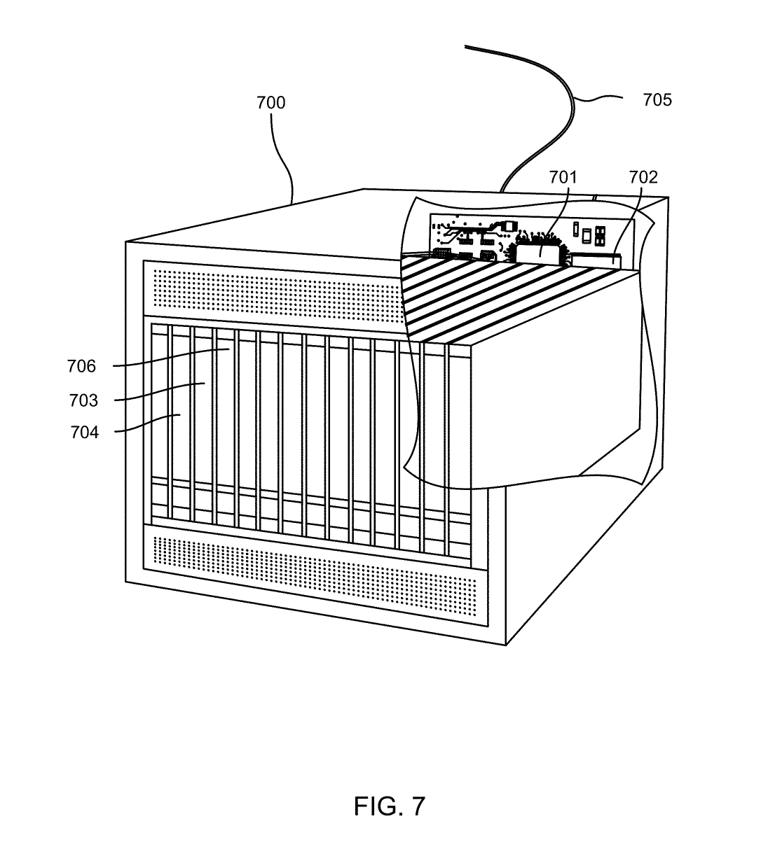

Various embodiments (including, but not limited to, embodiments described above with reference to FIGS. 1-4C) may also be implemented on any of a variety of commercially available server devices, such as the server 700 illustrated in FIG. 7. With reference to FIGS. 1-7, the server 700 may be similar to the computing devices 104-114, the network device 102, and the servers 116-120 described with reference to FIG. 1. As such, the server 700 may implement the method 200 of FIG. 2A.

Such a server 700 typically includes a processor 701 coupled to volatile memory 702 and a large capacity nonvolatile memory, such as a disk drive 704. The server 700 may also include a floppy disc drive, compact disc (CD) or DVD disc drive 706 coupled to the processor 701. The server 700 may also include one or more network transceivers 703, such as a network access port, coupled to the processor 701 for establishing network interface connections with a communication network 705, such as a local area network coupled to other announcement system computers and servers, the Internet, the public switched telephone network, and/or a cellular network (e.g., CDMA, TDMA, GSM, PCS, 3G, 4G, LTE, or any other type of cellular network).

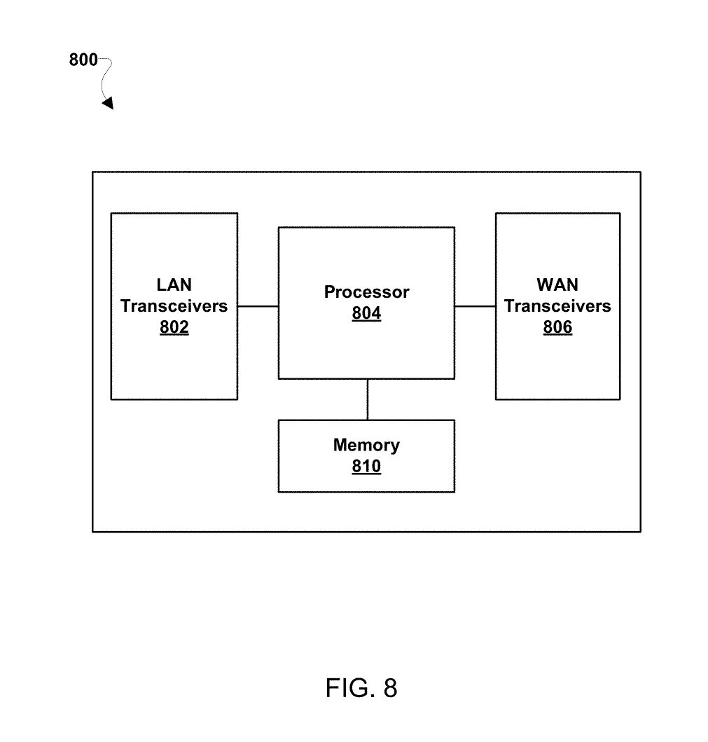

Various embodiments (including, but not limited to, embodiments described above with reference to FIGS. 1-4C) may also be implemented on any of a variety of commercially available network devices, such as routers, etc., such as the network device 800 illustrated in FIG. 8. In various embodiments, the network device 800 may be similar to the computing devices 104-114, the network device 102, and the servers 116-120 described with reference to FIG. 1. As such, the network device 800 may implement the method 200 of FIG. 2A.

With reference to FIGS. 1-8, such a network device 800 typically includes a processor 804 coupled to one or more memory 810, such as a volatile and/or nonvolatile memory. The network device 800 may also include one or more LAN transceivers 802, such as a wired or wireless network access port, coupled to the processor 804 for establishing LAN interface connections with connected computing devices. The network device 800 may also include one or more WAN transceivers 806, such as a wired or wireless network access port, coupled to the processor 804 for establishing WAN interface connections with a communication network, such as the Internet, the public switched telephone network, and/or a cellular network (e.g., CDMA, TDMA, GSM, PCS, 3G, 4G, LTE, or any other type of cellular network).

The processors described herein, such as processors 502, 611, 701, and/or 804, may be any programmable microprocessor, microcomputer or multiple processor chip or chips that can be configured by software instructions (applications) to perform a variety of functions, including the functions of various embodiments described below. In devices, multiple processors 502, 611, 701, and/or 804 may be provided, such as one processor dedicated to wireless communication functions and one processor dedicated to running other applications. Typically, software applications may be stored in the internal memory before they are accessed and loaded into the processors 502, 611, 701, and/or 804. The processors 502, 611, 701, and/or 804 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method of protecting computing devices from non-benign activity, comprising:
receiving, in a processor of a network device, a first network traffic flow of a monitoring computing device and a malicious activity tag identifying a non-benign behavior of the first network traffic flow;
determining, in the processor of the network device, one or more characteristics of the first network traffic flow associated with the non-benign behavior;
receiving, in the processor of the network device, a second network traffic flow from a non-monitoring computing device; and
determining, by the processor of the network device, whether the second network traffic flow represents non-benign activity by comparing the one or more characteristics of the first network traffic flow associated with the non-benign activity to the second network traffic flow.

2. The method of claim 1, further comprising:
clustering, by the processor of the network device, the first network traffic flow and the second network traffic flow based on characteristic of the second network traffic flow and the one or more characteristics of the first network traffic flow associated with the non-benign activity.

3. The method of claim 1, wherein the one or more characteristics of the first network traffic flow associated with the non-benign activity include information in packet headers of the first network traffic flow.

4. The method of claim 1, wherein the one or more characteristics of the first network traffic flow associated with the non-benign activity include one or more traffic features of the first network traffic flow.

5. The method of claim 1, wherein determining one or more characteristics of the first network traffic flow associated with the non-benign activity comprises:
learning, by a semi-supervised application of the network device, associations of the malicious activity tag with one or more characteristics of the first network traffic flow.

6. The method of claim 1, wherein determining whether the second network traffic flow represents non-benign activity by comparing the one or more characteristics of the first network traffic flow associated with the non-benign activity comprises:
comparing, by the processor of the network device, packet header information of the second network traffic flow with packet header information associated with the non-benign activity;
determining, by the processor of the network device, whether the packet header information of the second network traffic flow matches the associated with the non-benign activity; and
associating, by the processor of the network device, the malicious activity tag and the second network traffic flow in response to determining that the packet header information of the second network traffic flow matches packet header information associated with the non-benign activity.

7. The method of claim 1, wherein determining whether the second network traffic flow represents non-benign activity by comparing the one or more characteristics of the first network traffic flow associated with the non-benign activity comprises:
comparing, by the processor of the network device, a traffic feature of the second network traffic flow with a traffic feature associated with the non-benign activity;
determining, by the processor of the network device, whether the traffic feature of the second network traffic flow matches the traffic feature associated with the non-benign activity; and
associating, by the processor of the network device, the malicious activity tag and the second network traffic flow in response to determining that the traffic feature of the second network traffic flow matches the traffic feature associated with the non-benign activity.

8. The method of claim 1, wherein determining whether the second network traffic flow represents non-benign activity by comparing the one or more characteristics of the first network traffic flow associated with the non-benign activity comprises:
comparing, by the processor of the network device, packet header information of the second network traffic flow with packet header information associated with the non-benign activity;
comparing, by the processor of the network device, one or more traffic features of the second network traffic flow with one or more traffic features associated with the non-benign activity;
determining, by the processor of the network device, whether the packet header information and one or more traffic features of the second network traffic flow correlate to packet header information and the one or more traffic features associated with the non-benign activity within a threshold degree of correlation; and
associating, by the processor of the network device, the malicious activity tag and the second network traffic flow in response to determining that the packet header information and one or more traffic features of the second network traffic flow correlate to packet header information and the one or more traffic features associated with the non-benign activity within a threshold degree of correlation.

9. A network device, comprising:
a processor configured with processor-executable instructions to:
receive a first network traffic flow of a monitoring computing device and a malicious activity tag identifying a non-benign behavior of the first network traffic flow;
determine one or more characteristics of the first network traffic flow associated with the non-benign behavior;
receive a second network traffic flow from a non-monitoring computing device; and
determine whether the second network traffic flow represents non-benign activity by comparing the one or more characteristics of the first network traffic flow associated with the non-benign activity to the second network traffic flow.

10. The network device of claim 9, wherein the processor is further configured to cluster the first network traffic flow and the second network traffic flow based on characteristic of the second network traffic flow and the one or more characteristics of the first network traffic flow associated with the non-benign activity.

11. The network device of claim 9, wherein the processor is further configured such that the one or more characteristics of the first network traffic flow associated with the non-benign activity include information in packet headers of the first network traffic flow.

12. The network device of claim 9, wherein the processor is further configured such that the one or more characteristics of the first network traffic flow associated with the non-benign activity include one or more traffic features of the first network traffic flow.

13. The network device of claim 9, wherein the processor is further configured to learn associations of the malicious activity tag with one or more characteristics of the first network traffic flow.

14. The network device of claim 9, wherein the processor is further configured to:
compare packet header information of the second network traffic flow with packet header information associated with the non-benign activity;
determine whether the packet header information of the second network traffic flow matches the associated with the non-benign activity; and
associate the malicious activity tag and the second network traffic flow in response to determining that the packet header information of the second network traffic flow matches packet header information associated with the non-benign activity.

15. The network device of claim 9, wherein the processor is further configured to:
compare a traffic feature of the second network traffic flow with a traffic feature associated with the non-benign activity;
determine whether the traffic feature of the second network traffic flow matches the traffic feature associated with the non-benign activity; and
associate the malicious activity tag and the second network traffic flow in response to determining that the traffic feature of the second network traffic flow matches the traffic feature associated with the non-benign activity.

16. The network device of claim 9, wherein the processor is further configured to:
compare packet header information of the second network traffic flow with packet header information associated with the non-benign activity;
compare one or more traffic features of the second network traffic flow with one or more traffic features associated with the non-benign activity;
determine whether the packet header information and one or more traffic features of the second network traffic flow correlate to packet header information and the one or more traffic features associated with the non-benign activity within a threshold degree of correlation; and
associate the malicious activity tag and the second network traffic flow in response to determining that the packet header information and one or more traffic features of the second network traffic flow correlate to packet header information and the one or more traffic features associated with the non-benign activity within a threshold degree of correlation.

17. A network device, comprising:
means for receiving a first network traffic flow of a monitoring computing device and a malicious activity tag identifying a non-benign behavior of the first network traffic flow;
means for determining one or more characteristics of the first network traffic flow associated with the non-benign behavior;
means for receiving a second network traffic flow from a non-monitoring computing device; and
means for determining whether the second network traffic flow represents non-benign activity by comparing the one or more characteristics of the first network traffic flow associated with the non-benign activity to the second network traffic flow.

18. A non-transitory processor readable storage medium having stored thereon processor-executable instructions configured to cause a processor of a network device to perform operations comprising:
receiving a first network traffic flow of a monitoring computing device and a malicious activity tag identifying a non-benign behavior of the first network traffic flow;
determining one or more characteristics of the first network traffic flow associated with the non-benign behavior;
receiving a second network traffic flow from a non-monitoring computing device; and
determining whether the second network traffic flow represents non-benign activity by comparing the one or more characteristics of the first network traffic flow associated with the non-benign activity to the second network traffic flow.

19. The non-transitory processor readable storage medium of claim 18, wherein the stored processor-executable instructions are configured to cause the processor of the network device to perform operations further comprising:
clustering the first network traffic flow and the second network traffic flow based on characteristic of the second network traffic flow and the one or more characteristics of the first network traffic flow associated with the non-benign activity.

20. The non-transitory processor readable storage medium of claim 18, wherein the stored processor-executable instructions are configured to cause the processor of the network device to perform operations such that the one or more characteristics of the first network traffic flow associated with the non-benign activity include information in packet headers of the first network traffic flow.

21. The non-transitory processor readable storage medium of claim 18, wherein the stored processor-executable instructions are configured to cause the processor of the network device to perform operations such that the one or more characteristics of the first network traffic flow associated with the non-benign activity include one or more traffic features of the first network traffic flow.

22. The non-transitory processor readable storage medium of claim 18, wherein the stored processor-executable instructions are configured to cause the processor of the network device to perform operations such that determining one or more characteristics of the first network traffic flow associated with the non-benign activity comprises:
learning, by a semi-supervised application of the network device, associations of the malicious activity tag with one or more characteristics of the first network traffic flow.

23. The non-transitory processor readable storage medium of claim 18, wherein the stored processor-executable instructions are configured to cause the processor of the network device to perform operations such that determining whether the second network traffic flow represents non-benign activity by comparing the one or more characteristics of the first network traffic flow associated with the non-benign activity comprises:
comparing, by the processor of the network device, packet header information of the second network traffic flow with packet header information associated with the non-benign activity;
determining, by the processor of the network device, whether the packet header information of the second network traffic flow matches the associated with the non-benign activity; and
associating, by the processor of the network device, the malicious activity tag and the second network traffic flow in response to determining that the packet header information of the second network traffic flow matches packet header information associated with the non-benign activity.

24. The non-transitory processor readable storage medium of claim 18, wherein the stored processor-executable instructions are configured to cause the processor of the network device to perform operations such that determining whether the second network traffic flow represents non-benign activity by comparing the one or more characteristics of the first network traffic flow associated with the non-benign activity comprises:
comparing, by the processor of the network device, a traffic feature of the second network traffic flow with a traffic feature associated with the non-benign activity;
determining, by the processor of the network device, whether the traffic feature of the second network traffic flow matches the traffic feature associated with the non-benign activity; and
associating, by the processor of the network device, the malicious activity tag and the second network traffic flow in response to determining that the traffic feature of the second network traffic flow matches the traffic feature associated with the non-benign activity.

25. The non-transitory processor readable storage medium of claim 18, wherein the stored processor-executable instructions are configured to cause the processor of the network device to perform operations such that determining whether the second network traffic flow represents non-benign activity by comparing the one or more characteristics of the first network traffic flow associated with the non-benign activity comprises:
comparing, by the processor of the network device, packet header information of the second network traffic flow with packet header information associated with the non-benign activity;
comparing, by the processor of the network device, one or more traffic features of the second network traffic flow with one or more traffic features associated with the non-benign activity;
determining, by the processor of the network device, whether the packet header information and one or more traffic features of the second network traffic flow correlate to packet header information and the one or more traffic features associated with the non-benign activity within a threshold degree of correlation; and
associating, by the processor of the network device, the malicious activity tag and the second network traffic flow in response to determining that the packet header information and one or more traffic features of the second network traffic flow correlate to packet header information and the one or more traffic features associated with the non-benign activity within a threshold degree of correlation.
